(19) United States
(12) Patent Application Publication
(10) Pub. No.: US 2021/0405189 A1
(43) Pub. Date: Dec. 30, 2021

(54) Range Determination from Differential Atmospheric Acoustic Absorption

(71) Applicant: Izak Jan van Cruyningen, Saratoga, CA (US)

(72) Inventor: Izak Jan van Cruyningen, Saratoga, CA (US)

(21) Appl. No.: 17/361,792

(22) Filed: Jun. 29, 2021

Related U.S. Application Data
(60) Provisional application No. 63/046,563, filed on Jun. 30, 2020.

(51) Int. Cl. G01S 15/93; G01S 15/08

(52) U.S. Cl. CPC G01S 15/93; G01S 15/08

(57) ABSTRACT

To estimate distance to a sound source with a characteristic spectrum, normalize the measured spectrum and compare with that predicted by absorption of sound under current atmospheric conditions.

### CROSS-REFERENCE TO RELATED APPLICATIONS

This application claims the benefit of provisional patent application Ser. No. 63/046,563 filed 2020 Jun 30 by the present inventor.

### FIELD

This invention relates to measuring distance to a sound source using the differential absorption of sound in the atmosphere.

### BACKGROUND

### Prior Art

Collision avoidance requires measurement of range to a vehicle. Moving vehicles generate sound, for example, from the engine, from airflow over the body, or from contact with a road. The generated sound becomes quieter further from the source both due to geometric expansion of the sound energy, as well as absorption of the sound in the atmosphere.

If the sound pressure level (SPL) of the source at a reference distance is known, a measurement at another distance from the source can estimate the range to the source assuming geometric expansion of −6 dB for each doubling of distance. The challenge is that SPL varies significantly from model to model of vehicles, from individual instances of a model, and even for different operating conditions of the same vehicle.

The distribution of sound into different frequencies varies less. That is how people recognize different vehicles, whether they are close-by or far away. The rumble of a Harley-Davidson™ motorcycle can be quiet or very loud depending on the throttle, but it is always a low-pitched signature rumble with a characteristic spectrum.

The distribution of sound changes as it propagates through the atmosphere because higher frequencies are absorbed faster. This change in distribution can be used to determine range, independent of the original sound pressure level. You can determine the distance to that Harley-Davidson motorcycle regardless if it is idling at a red light or roaring away on green.

### SUMMARY

To estimate distance to a sound source with a characteristic spectrum, normalize the measured spectrum and compare with that predicted by absorption of sound under current atmospheric conditions.

### ADVANTAGES

The proposed acoustic ranging system allows measurements to a sound source with a characteristic spectrum, independent of the sound level emitted. For vehicles, the absolute sound levels emitted vary with different operating conditions, different vehicle instances, or different models. Measuring absolute sound level does not allow reliable prediction of distance. Normalizing by the overall sound level and measuring spectrum changes due to differential absorption is a much more robust approach.

Other advantages of one or more aspects will be apparent from a consideration of the drawings and ensuing description.

### FIGURES

FIG. 1. Perspective View of a Sound Source and Acoustic Ranging System.

FIG. 2. Acoustic Ranging from a Vehicle.

FIG. 3. Characteristic Spectrum of a Propeller

FIG. 4. Characteristic Spectrum 10 m from a Truck Muffler

FIG. 5. Characteristic Spectra of a Truck and a Car

FIG. 6. Atmospheric Absorption of Sound vs Frequency at 20C, 70% relative humidity, 1 atm.

FIG. 7. Propeller Acoustic Spectra at Different Distances.

FIG. 8. Normalized Propeller Acoustic Spectra at Different Distances.

FIG. 9. Flowchart of Acoustic Ranging Method.

### DETAILED DESCRIPTION

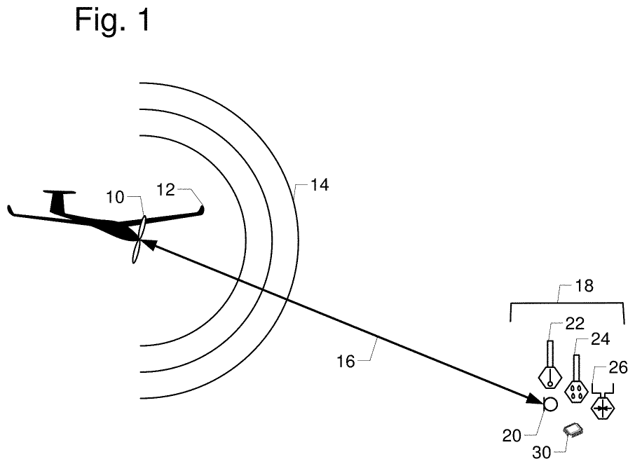

This section describes several embodiments of the acoustic ranging system with reference to FIGS. 1-9.

FIG. 1 is a perspective view of a sound source and acoustic ranging system. Propeller 10 on aircraft 12 generates sound wave 14. At distance or range 16 is acoustic ranging system 18. It contains acoustic sensor 20, thermometer 22, humidity sensor 24, pressure sensor 26, and processor and memory 30.

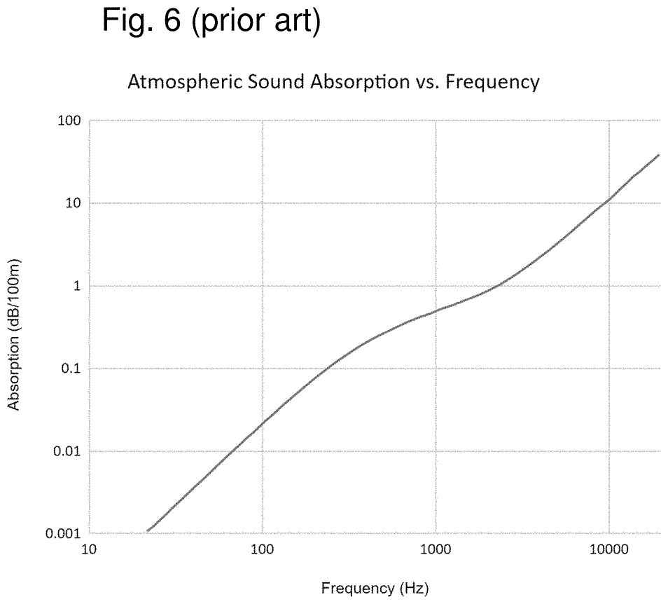

Sound wave 14 spreads spherically with a geometric pressure loss of 6 dB for each doubling of distance. It also attenuates due to absorption in the atmosphere that depends on the frequency of sound wave 14, as shown in FIG. 6.

Acoustic sensor 20 could be a microphone like an electret, condenser, piezoelectric, surface acoustic wave, or any other acoustic sensor that is able to record sound wave 14. Thermometer 22, humidity sensor 24, and pressure sensor 26 are atmospheric sensors that measure atmospheric conditions. If the temperature, pressure, or humidity is not expected to vary at the location of acoustic ranging system 18, then the corresponding sensor does not need to be installed. Processor and memory 30 stores the recordings from acoustic sensor 20 and the measurements of thermometer 22, humidity sensor 24, and pressure sensor 26 and then calculates range 16 from the differential absorption of sound wave 14, as described below. Processor and memory may be integral to acoustic ranging system 18, they may be in another local device, e.g. a cell phone connected with a wire or wirelessly, or they may be on a remote server with a wireless connection.

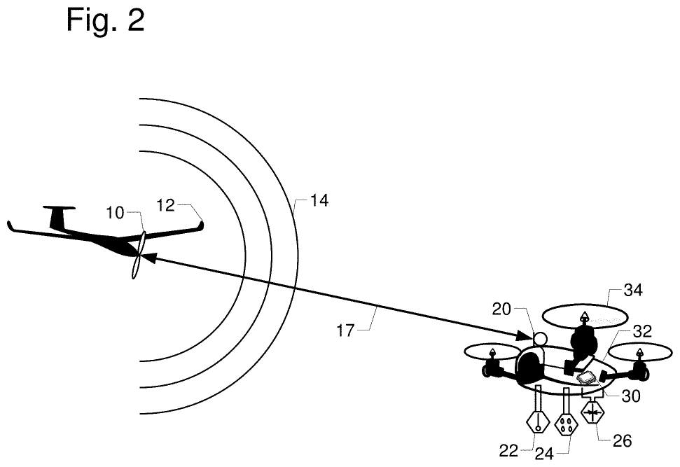

FIG. 2 is a perspective view of a sound source and the acoustic ranging system components mounted on a vehicle. Propeller 10 on aircraft 12 generates sound wave 14. At range 17 is second airframe 32 supporting acoustic sensor 20, thermometer 22, humidity sensor 24, pressure sensor 26, processor and memory 30, and propellers 34.

Processor and memory 30 stores the recordings from acoustic sensor 20 and the measurements of thermometer 22, humidity sensor 24, and pressure sensor 26 and then calculates range 17 from the differential absorption of sound wave 14. Processor and memory 30 may be a separate component, or it may be an existing component, e.g., the autopilot, of second airframe 32. Second airframe 32 may be a crewed aircraft or an uncrewed aerial vehicle (UAV).

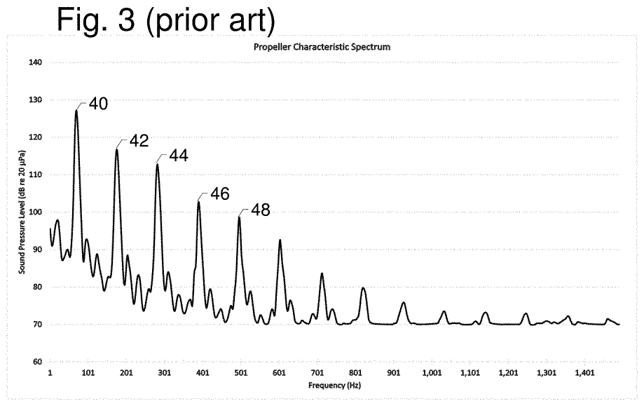

FIG. 3 is a characteristic spectrum of a Cessna 172, a general aviation aircraft with a two-bladed propeller. The fundamental frequency 40 at about 80 Hz is the loudest, with second harmonic 42, third harmonic 44, fourth harmonic 46, fifth harmonic 48, and further harmonics progressively quieter. This spectrum can be measured at a known distance in the far field of the sound source. It can also be calculated, as described in Appendix B of “A Review of Aerodynamic Noise from Propellers, Rotors, and Lift Fans”, J. E. Marte and D. W. Kurtz, Technical Report 32-1462, NASA JPL 1970. Their Fig. B-6 shows how to calculate the fraction of sound at each harmonic, thus the progression of quieter peaks for higher harmonics in FIG. 3.

Applying their calculations to other classes of airframes show a three bladed general aviation propeller has a fundamental frequency of about 120 Hz, a helicopter less than 25 Hz, and a typical UAV over 250 Hz. A more sophisticated computational fluid dynamics (CFD) model will provide more detailed characteristic spectra.

Note the possible difference in characteristic spectra for the airframes in FIG. 2. If aircraft 12 is a crewed general aviation aircraft with two propeller blades it will have a fundamental frequency at cruise near 80 Hz with harmonics at 160, 240, 320, 400 Hz, etc. If second airframe 32 is a multicopter UAV, then its fundamental frequency may be 250 Hz with harmonics at 500, 750, 1000 Hz, etc. These characteristic spectra can be well described by a plurality of frequencies consisting of the fundamental and its harmonics. These frequencies are louder than nearby ones and so provide better signal to noise for acoustic sensor 20.

To remove the sound from second airframe's 32 own propellers 34, processor and memory 30 on second airframe 32 can implement notch filters for the fundamental and harmonic frequencies of propellers 34. This removes self-sound at second airframe's 32 own fundamental and harmonic frequencies from propellers 34 while preserving the acoustic signal from propeller 10 on aircraft 12.

The sound levels in FIG. 3 are shown in sound pressure level (dB re 20 μPa). Sound levels can be measured in many ways, e.g., power, intensity, pressure level, velocity, A weighted, C weighted units, and others.

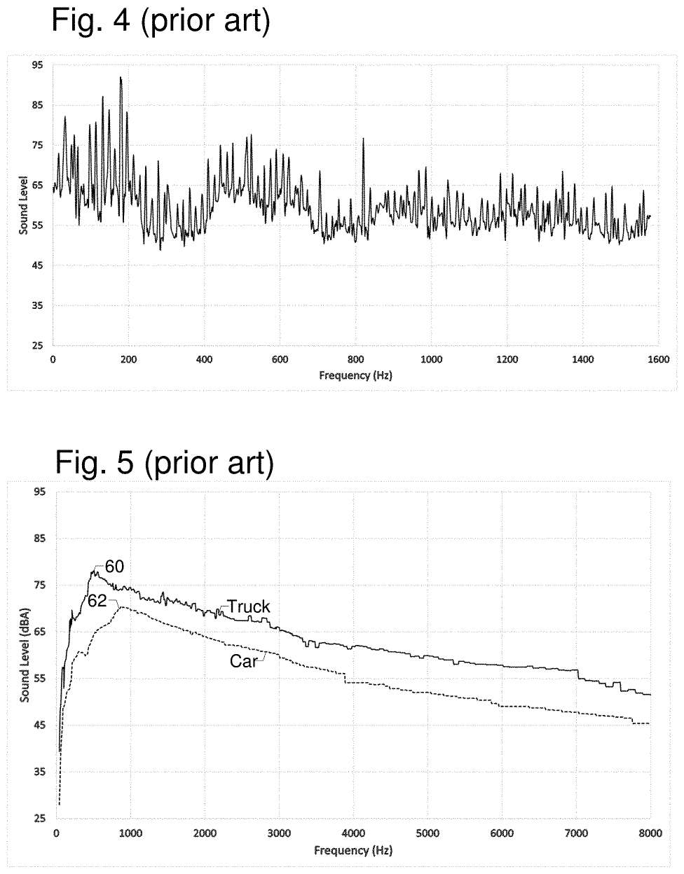

FIG. 4 is a characteristic spectrum of a truck engine measured 10 m from the muffler. The engine has many more moving parts than a simple propeller, so the spectrum has many more peaks and valleys.

FIG. 5 illustrates characteristic spectra of a truck and a car. When you combine sound from the tire/road interaction, engine, transmission, air intake, exhaust, aerodynamic noise, body and wheel vibration the spectrum becomes much fuller and smoother. The truck still has a typical peak at 550 Hz 60 and the car at 880 Hz 62. The smoother shape of the characteristic spectrum can be described at a plurality of frequencies chosen over the range of response for acoustic sensor 20.

FIGS. 3 to 5 showed characteristic spectra for propellers, engines, trucks, and cars. Other vehicles such as boats, trains, or jet aircraft also have characteristic spectra. These can be used to detect a vehicle and calculate its range to a stationary position as shown in FIG. 1, e.g. an aircraft approaching an airport, a car approaching an intersection, or a train approaching a switch. The components can also be mounted on moving vehicles as shown in FIG. 2 to detect and calculate the range to an approaching aircraft, car, truck, boat, etc. More broadly, the range can be estimated to any sound source with duration long enough to measure a characteristic spectrum.

FIG. 6 is a chart of atmospheric sound absorption for a pressure of one atmosphere, temperature of 20° C., and 70% relative humidity. The absorption increases with frequency due to
Viscous and thermal losses from molecular friction that increase as the square of frequency over the whole frequency range.
Nitrogen relaxation that increases with frequency up to about 800 Hz.
Oxygen relaxation that increases with frequency up to about 20,000 Hz.
Water vapor vibrational, rotational, and translational energy.

Charts like FIG. 6 to predict the atmospheric absorption for different atmospheric conditions can be produced from a well-known set of equations. In U.S. Pat. No. 9,146,295B2, Jiang, Daily, and Kremer reproduce equations (11), (12), (13), and (14) for atmospheric absorption based on frequency, temperature, pressure, and relative humidity. They do not mention absorption further, instead developing the idea of measuring time delays for dispersion of the harmonics. The means to predict atmospheric absorption for specific atmospheric conditions can be in the form of equations, charts, tables, and software programs. All four are illustrated in the Web page at https://en.wikibooks.org/wiki/Engineering Acoustics/Outdoor Sound Propagation.

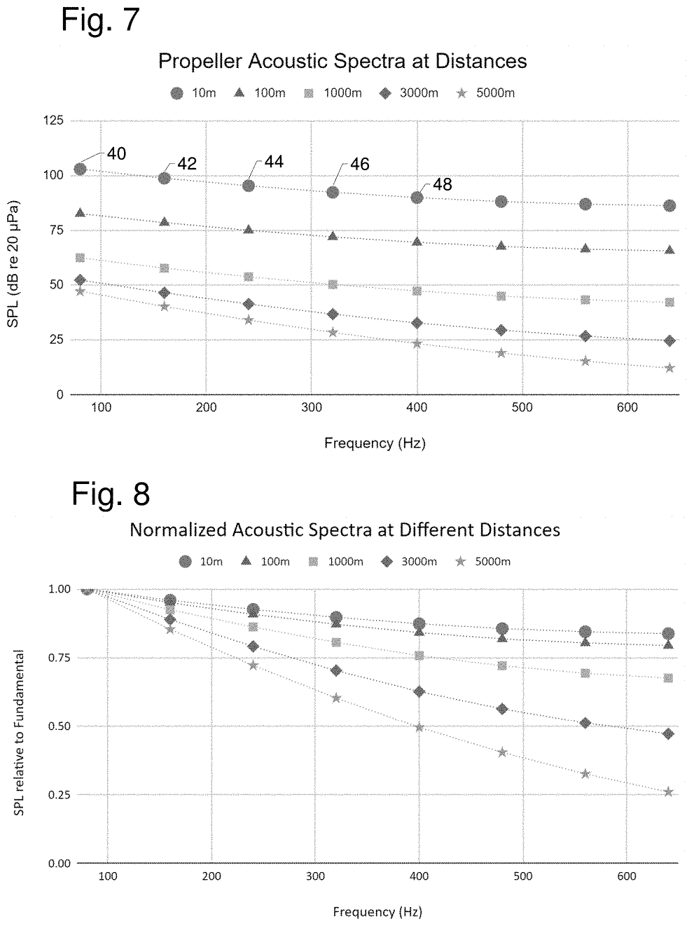

FIG. 7 shows the change in sound wave 14 from propeller 10 as it propagates through the atmosphere. The characteristic spectrum at 10 m is described by the peaks in FIG. 3, namely the fundamental 40 and the second 42, third 44, fourth 46, fifth 48, and higher harmonic frequencies. As sound wave 14 propagates it becomes quieter by 6 dB for each doubling of distance due to geometric spreading. This moves the spectrum uniformly down in FIG. 7. A second source of attenuation, atmospheric absorption differentially attenuates the high frequencies. The successive spectra have steeper slopes.

FIG. 8 shows the normalized acoustic spectra at different distances. For each distance, the sound level at each harmonic is divided by the value at the fundamental. This removes the effect of geometric spreading and accentuates the effect of atmospheric absorption. The increasing slope at further distances is very clear and measurable. At longer ranges both the overall sound level decreases and the curve versus frequency gets steeper. This increasing steepness of the curve is due to the differential absorption and can be used to estimate range independent of overall sound level.

The normalization for FIG. 8 was done using the sound level at the fundamental. Many other normalizations are possible, e.g., the average sound level, the geometric mean of the sound levels at the harmonics, or any other measure indicative of the overall sound level at that distance.

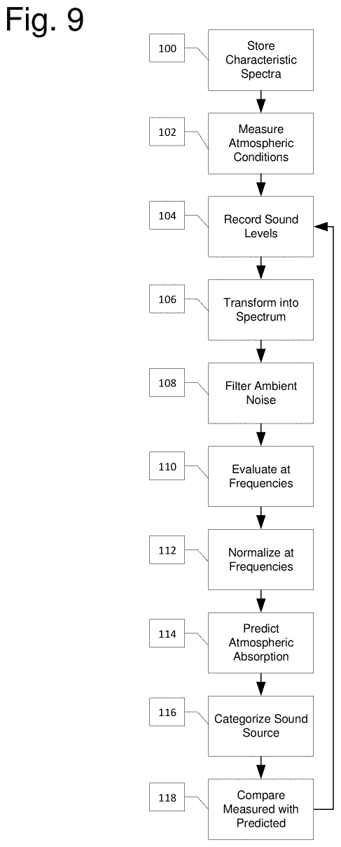

FIG. 9 is a flowchart describing acoustic ranging from differential atmospheric absorption. The initial step is to store characteristic spectra 100 of potential sound sources. For example, if the acoustic ranging system 18 of FIG. 1 is to be deployed at an airport, then store spectra typical of the types of planes that land there, e.g., general aviation with two-bladed and three-bladed propellers, helicopters, and jets. If the apparatus is mounted on an UAV like in FIG. 2, store the same aviation spectra as well as the characteristic spectrum of the UAV itself. This self-spectrum can be considered ambient noise and either be measured when other aircraft are not audible, or calculated from models. Similarly, if acoustic ranging system 18 is set up near equipment creating ambient noise, say an air conditioner, then store the characteristic spectrum of the ambient noise.

The potential sound sources and their spectra depend on the application domain, e.g.
Takeoff, cruise, and landing spectra of airframes for mounting at airports, on airframes, and on UAVs;
car, truck, and motorcycle spectra for traffic signals or mounting on roadway vehicles;
train spectra for railway switches;
vessel spectra for mounting on harbor buoys or boats, etc.

The stored characteristic spectra 100 are assumed to all be at a standard distance, say 10 m or multiple wavelengths, from the sound source. Spectra generated by modelling can use the standard distance in the model. If a spectrum is measured at a different distance, it can be standardized by using charts like FIG. 6 or the corresponding equations, tables, or programs with the atmospheric conditions at the time of measurement.

As discussed with respect to FIG. 6, the acoustic absorption by the atmosphere depends on the temperature, pressure, and humidity. Measuring atmospheric conditions 102 allows later prediction of the absorption 114 for current atmospheric conditions.

As sound sources come into audible range for acoustic sensor 20, record sound levels 104. Then transform the recording into an acoustic spectrum 106 with processor and memory 30 using a transform into the frequency domain like a fast Fourier transform, short-term Fourier transform, discrete cosine transform, or similar.

If step 100 stored an ambient noise spectrum, either from self-sound of the vehicle or from nearby sound sources, filter the ambient noise 108 with a denoising technique, e.g., frequency subtraction, Ephraim-Malah, or similar.

Next evaluate the spectrum at a number of frequencies 110. If the spectrum has clear peaks, as shown in FIG. 3, choose frequencies that include those peaks for improved signal to noise. If it is a fuller, smoother spectrum as shown in FIG. 5, the choice is more flexible. You can choose frequencies distributed over the range of sensitivity of acoustic sensor 20.

As discussed for FIG. 8 in paragraphs [0025] [0026] normalizing the sound levels at the chosen frequencies 112 accentuates the contribution of absorption on the attenuation of sound wave 14 as it propagates.

Then predict the atmospheric absorption 114 at the normalized frequencies given the measured atmospheric conditions 102. As discussed in [0023] prediction can be done from equations, charts, tables, or software code on processor and memory 30.

Optionally categorize the sound source 116. For example, at a smaller airport the most likely categories of airframes you will encounter along with their fundamental frequencies at cruise are
General aviation aircraft with two propeller blades: Cessna 152&172 (80 Hz), Piper 28-140 (83 Hz), Piper J3C-65 (72 Hz), or Aeronca 7AC (73 Hz),
General aviation aircraft with three propeller blades: Cessna 182Q (120 Hz), Mooney M20J (120 Hz), Cirrus SR22 (125 Hz), Beechcraft V35B (120 Hz), or Piper PA-32-300 (115 Hz), and
Helicopters: Robinson R22 (20 Hz), R44 (17.4 Hz), R66 (17.5 Hz), or Bell 206 (15.4 Hz),
   For example, if the loudest frequency in the recorded spectrum 106 is 75 Hz and the spectrum has peaks at multiples of that, then the sound source is likely a general aviation aircraft with a two-bladed propeller. This narrows down the list of potential sound sources.

Compare the measured with predicted sound levels 118 to determine the distance 16 between the sound source and acoustic sensor 20. This can be done in a number of different ways such as an algebraic minimization, a least squares fit, to a full gradient descent implementation. For example, for each stored characteristic spectrum 100, or for the spectra in the matching category 116, predict the spectrum at a number of distances. Then calculate the difference between the predicted and measured. The smallest difference will be the distance to the sound source.

Another approach is to solve for distance in terms of attenuation. Then at each of the normalized frequencies 110, predict the distance and choose the best fit. This would be like fitting the curve in FIG. 8.

After predicting the distance, record a new set of sound levels 104. For longer durations or for rapid atmospheric changes, also measure the atmospheric conditions 102 on each iteration to get the best possible absorption predictions.

This section illustrated details of specific embodiments, but persons skilled in the art can readily make modifications and changes that are still within the scope.

I claim:

1. A method for determining the distance between a sound source with a characteristic spectrum and an acoustic ranging system comprising,
measuring at least one atmospheric condition with an atmospheric sensor,
recording sound levels from the sound source with an acoustic sensor,
providing a processor and memory for transforming the sound levels into an acoustic spectrum,
evaluating the sound level at each of a plurality of frequencies in the acoustic spectrum,
normalizing the sound level at each of the plurality of frequencies,
predicting the differential absorption from the measured atmospheric conditions, and comparing the normalized sound levels with the predicted differential absorption of the characteristic spectrum to determine the distance.

2. The method of claim 1, preceded by
storing a plurality of characteristic spectra of potential sound sources with said processor and memory, and
said comparing compares each of the plurality of characteristic spectra.

3. The method of claim 1, further including
storing the ambient spectrum of ambient sound from sound sources near the acoustic ranging system, and
filtering the stored ambient spectrum of ambient sound from the acoustic spectrum of the recorded sound levels.

4. The method of claim 3, wherein the acoustic ranging system is mounted on a vehicle, and the ambient spectrum includes the characteristic spectrum of the sound emitted by the vehicle.

5. The method of claim 1, wherein the atmospheric condition is selected from at least one of humidity, pressure, and temperature.

6. The method of claim 1, further including the categorizing the sound source from the sound levels at the plurality of frequencies.

7. An acoustic ranging apparatus to determine the distance to a sound source with a characteristic spectrum comprising,
an acoustic sensor to measure sound levels,
at least one atmospheric condition sensor to measure atmospheric conditions, and
a processor and memory to transform the measured sound levels into a spectrum,
normalize the spectrum,
predict differential absorption under the measured atmospheric conditions, and
compare the normalized spectrum with the predicted differential absorption of the characteristic spectrum of the sound source to determine the distance.

8. The apparatus of claim 7 wherein the atmospheric condition sensor is selected from the group consisting of thermometers, pressure sensors, and humidity sensors.
